(19) United States
(12) Patent Application Publication
(10) Pub. No.: US 2014/0175801 A1
(43) Pub. Date: Jun. 26, 2014

(54) WIND TURBINE POWER GENERATOR

(71) Applicant: Charles T. Valenza, Elk Grove, CA (US)

(72) Inventor: Charles T. Valenza, Elk Grove, CA (US)

(21) Appl. No.: 14/138,822

(22) Filed: Dec. 23, 2013

Related U.S. Application Data
(60) Provisional application No. 61/740,771, filed on Dec. 21, 2012.

(51) Int. Cl. F03D 3/06; F03D 3/00; F03D 9/00

(52) U.S. Cl. CPC F03D 3/065; F03D 9/002; F03D 3/002
USPC 290/55

(57) ABSTRACT

A wind turbine generator, particularly designed for de-centralized and mobile use, having a generally spherical shape formed from multi-bladed hemispheres connected at the equator of the spherical shape is disclosed. The inventive wind turbine generator is designed to be smaller in size, lighter in weight, and, in certain preferred embodiments, readily portable to permit installation in a wide variety of locations, including residential and business structures, as well as part of public and private infrastructures, including by way of example bridges, tunnels, and water towers.

### FIELD OF THE INVENTION

The present invention relates generally to the field of wind turbine generation systems and, in more particularity, to a wind turbine power generation system designed for de-centralized usage within a wide variety of power generation and usage applications.

### BACKGROUND OF THE INVENTION

The disclosed invention generally relates to wind turbine systems, including the controls and equipment for generating and transferring electric energy. More particularly, the disclosed invention relates to a wind turbine power generation system that is designed for a de-centralized use in connection with a wide variety of power usage applications. In one or more preferred embodiments, the wind turbine systems could be configured to be readily portable for use in varied locations.

By way of summary background, wind turbine systems are widely known and many configurations for such systems have been designed and implemented. However, the drawbacks for the current wind turbine systems and designs are numerous and substantial. Some of the major drawbacks severely limiting the market and precluding the wide-spread acceptance of wind generated energy systems include, without limitation: prohibitive initial cost of equipment and installation, maintenance and repair costs, narrow criteria to gain cost efficient operating utility based on location climate and wind conditions, structural specifications and installation needs to gain acceptable utility, safety concerns for property and living entities (human and animal), possible adverse effects to the natural environment and wildlife, including noise pollution, and objectionable aesthetics as raised by some communities. In summary, there exist many reasons that there are not more wind turbine generators, of any size, to convert wind into energy at more locations.

In view of these types of often cited objections, one could describe the “ideal wind turbine location” is having the following attributes: (a) constant sufficient smooth wind flow for a high percentage of the measured period of time to cover and exceed its utility cost; (b) location near the electrical transmission grid, or at least near enough to concentrations of electrical users, to not incur high energy transmission costs; (c) having limited or no public access and have a buffering perimeter to allay safety risks to the general public; (d) be isolated to protect communities from noise pollution; (e) not pose a risk to wildlife, particularly those classified as officially endangered, specifically birds, flying mammals or adversely impact terrestrial wildlife habitats; (f) be close enough to communities where maintenance and repair workers are available at a reasonable cost; and (g) be out-of-visual-sight of those communities that object to the aesthetics of the plant or energy faun.

Most wind energy devices and turbines are commonly divided into two categories: Horizontal Axis Wind Turbines (“HAWT”) or Vertical Axis Wind Turbines (“VAWT”). Though the above restrictions may appear to be directed to large, commercial wind turbines and wind energy farms of HAWTs or VAWTs, with large propeller-like blades mounted on rotor towers standing hundreds of feet high, the same objections have also substantially curtailed smaller wind plant installations in all types of locations, including urban, suburban and rural sites, whether residential, commercial or public commons infrastructure.

For residential use, wind energy plants are mainly installed as a best choice necessity where no electrical grid is available and at costs higher than would have been associated with electrical grid power when equipment, installation and battery maintenance costs are factored. The initial cost and financing of equipment and installation make wind energy plants generally unpopular and unappealing even for those potential rural users on the electric gird who have the option of net-metering, which eliminates the need for electrical storage devices and the associated maintenance and/or replacement costs of such storage devices.

For suburban and urban residential sites, HAWT energy plant designs, including systems using either standard propeller-type blades or horizontally rotary mounted blades, have not achieved general acceptance because of issues relating to safety, noise and vibration. Such concerns are raised most often where the system is installed on residential building structures. Community noise and safety concerns and government regulations have often been cited to limit the installation of such plants on parcels of land that might otherwise be acceptable sites.

For commercial buildings, similar issues and objections as those noted above for residential buildings also apply with the possible exception of new construction and retrofit buildings where structural features, including isolation devices, are installed to overcome some of these issues. For mixed use sites that are open to the public, safety and noise concerns generally restrict use of HAWT plant installations. As an alternative to the HAWT systems, some sites have installed and operated VAWT, but again due to at least reasons of cost, system efficiency, inconsistent wind conditions, and slow return on investment, this option has similarly not been widely accepted.

It has also been proposed that certain common infrastructure sites or objects, some which either create their own wind, like highway and railways, tunnels and underpasses, or others that have above average exposure to natural wind, like bridges, are good candidates for the generation of energy via wind plants. There are however, many objections to wind generation turbines being installed at or on such sites, including capital expenditure costs, shutdowns or restrictions on the primary function of the asset, and often most important, safety concerns associated with both equipment, installation, and system mounting failures. For example, with respect to certain infrastructure, including bridges, vibrations from the wind energy plant operation may result in structural concerns due to vibratory loads.

With respect to differences between HAWT and VAWT systems, it is generally agreed that HAWT devices are more efficient at converting wind energy into the kinetic rotation necessary to generate electrical energy. This advantage has been attributed to the use of lift generated by the HAWT airfoils and the counterweight forces (due to gravity) to the spinning blades. Though VAWT devices also employ aerodynamic forces of lift in some form, and theoretically could be as efficient in wind energy conversion when compared to HAWT devices, to date they similarly have not been able to achieve high levels of efficiency without suffering from other disadvantages. Moreover, most VAWT systems are not designed to utilize the force of gravity as part of their propulsion system. The perceived advantage of VAWT designs appears to be the simplicity of direct drive to the electrical generator, as well as quiet and safe operation, though these latter attributes are often not fully realized.

While VAWT designs appear to be safer than HAWT designs, because there are no propeller type blades freely spinning, the VAWT designs have similar issues with installation. More particularly, VAWT designs require a stable mounting structure for safe operation due to their vertical, standing position. This mounting structure constraint often limits where such prior art devices can be deployed. Manufacturers, industry literature and plans for most all wind turbines stress the importance of a strong structure that can withstand the forces generated through the wind turbine device. Indeed, installation on roof tops is nearly universally discouraged.

Most all wind energy conversion devices in viable operation today are of the HAWT design. Moreover, nearly all of these are single or multiple spinning propeller type blade rotors. Examples of such HAWT turbines are disclosed in U.S. Pat. No. 4,306,315 (Olson); U.S. Pat. No. 4,311,918 (Vaseen); U.S. Pat. No. 4,285,636 (Kato et al.); U.S. Pat. No. 6,616,402 (Selsam); and U.S. Pat. No. 7,315,093 (Graham, Sr.), which teach designs or improvements to designs for systems, control, airfoils, and transmissions related to basic HAWT designs. Though there are various designs for HAWT devices with horizontally mounted rotary blades, none has achieved any level of public acceptance to date. Other designs are shown in U.S. Pat. No. 4,151,424 (Baily); U.S. Pat. No. 4,417,853 (Cook); U.S. Pat. No. 4,659,940 (Shepard); U.S. Pat. No. 7,362,004 (Becker); U.S. Pat. No. 7,849,596 (Sauer et al.); U.S. Pat. No. 8,096,750 (McEntee et al.); U.S. Pat. No. 8,137,052 (Schlegel); U.S. Pat. No. 8,148,838 (Ferguson); U.S. Pat. No. 8,178,987 (Mahawili); U.S. Pat. No. 8,268,030 (Abromov); and U.S. Pat. No. 8,278,777 (Buns). Moreover, one horizontal oriented design is shown in U.S. Pat. No. 5,103,646 (Fini), combines the conversion of wind and solar energy via the use of heating liquid in a spherical furnace containment.

Similarly, the VAWT or panemone wind turbine dates back hundreds of years. Recent design innovations employ varying airfoil blades where lift is employed for propulsion. A very old design, by Darrieus (U.S. Pat. No. 1,835,018), suggests a turbine having a plurality of vertical, airfoil-like blades supported at the top and bottom for rotation around a central vertical axis. However the basic Darrieus design is subject to several problems including failure of the structure at the blade joints. More recent innovations for VAWT designs include those shown in U.S. Pat. No. 4,168,439 (Palma); U.S. Pat. No. 5,405,246 (Goldberg); U.S. Pat. No. 5,531,567 (Hulls); U.S. Pat. No. 7,344,353 (Naskali et al.); U.S. Pat. No. 7,400,057 (Sureshan); U.S. Pat. No. 7,980,823 (Akamine); U.S. Pat. No. 7,980,810 (Unno); U.S. Pat. No. 8,084,881 (Morgan); U.S. Pat. No. 8,038,383 (Sharpe); U.S. Pat. No. 8,061,993 (Sassow); and U.S. Pat. No. 8,210,792 (Suma).

What is still needed is a wind turbine system that meets the above identified important attributes, and be able to be de-centralized for usage in a variety of energy requiring applications. Such systems and devices do not appear to have been developed. The disclosed systems and devices do fully address the prior art deficiencies and problems.

### SUMMARY OF THE INVENTION

The present invention is, in preferred embodiments, a wind turbine generator device and system for creating electrical energy from a spherical-shaped wind-driven turbine comprising a spherical-shaped element comprising a plurality of blades each having a proximate end and a distal end, wherein said plurality of blades are shaped and formed into a spherical shape wherein said proximate end of each of said plurality of blades are connected at a center axis; said distal end of each of said plurality of blades are connected to a circumference of said spherical shape; a gear element attached to said spherical-shaped element; and a generator driven by said gear element as said spherical-shaped element rotates as a result of wind forces, wherein said generator creates electricity as it is driven by said spherical-shaped element.

In another preferred embodiment of the present invention, the wind turbine generation system comprises a plurality of wind turbine generation devices, wherein each said plurality of wind turbine generation devices further comprises a spherical-shaped element comprising a plurality of blades each having a proximate end and a distal end, wherein said plurality of blades are shaped and formed into a spherical shape wherein said proximate end of each of said plurality of blades are connected at a center axis; said distal end of each of said plurality of blades are connected to a circumference of said spherical shape; a gear element attached to said spherical-shaped element; and a generator driven by said gear element as said spherical-shaped element rotates as a result of wind forces, wherein said generator creates electricity as it is driven by said spherical-shaped element.

In still another preferred embodiment of the present invention, a method for generating electrical power from wind energy using a wind turbine generation device comprising a spherical-shaped wind-driven turbine device, where the wind turbine generation device comprises a spherical-shaped element comprising a plurality of blades each having a proximate end and a distal end, wherein said plurality of blades are shaped and formed into a spherical shape wherein said proximate end of each of said plurality of blades are connected at a center axis; said distal end of each of said plurality of blades are connected to a circumference of said spherical shape; a gear element attached to said spherical-shaped element; and a generator driven by said gear element as said spherical-shaped element rotates as a result of wind forces, wherein said generator creates electricity as it is driven by said spherical-shaped element.

### BRIEF DESCRIPTION OF THE DRAWINGS

FIG. 1 shows a side view of an exemplary embodiment of the wind turbine generator with the wind direction from left to right and a counterclockwise rotation of the spherical shaped turbine;

FIG. 1A shows another side view of an exemplary embodiment of the wind turbine generator with the wind direction from left to right and a counterclockwise rotation of the spherical shaped turbine;

FIG. 2 shows a front view of an exemplary embodiment of the wind turbine generator;

FIG. 2A shows a front view of the base element to assist in directing wind into the wind turbine generator;

FIG. 3 shows a detailed front view of an exemplary embodiment of the wind turbine generator showing the circumferential gear as connected to the generator;

FIG. 3A shows a partial side view of an exemplary embodiment of the wind turbine generator showing the bearing gears used to control the spherical shaped turbine;

FIG. 4 shows a side view of an exemplary embodiment of the wind turbine generator main circumferential gear;

FIG. 5 shows a side view of an exemplary embodiment of the wind turbine generator with a vertical directional vane, and with the wind direction from left to right and a counterclockwise rotation of the spherical shaped turbine;

FIG. 5A shows another side view of an exemplary embodiment of the wind turbine generator with the wind direction from left to right and a counterclockwise rotation of the spherical shaped turbine;

FIG. 6 shows a top view of is an exemplary embodiment of the wind turbine generator with a vertical directional vane, and with the wind direction from left to right; and

FIG. 7 shows a side view of an exemplary embodiment of a wind turbine generator system comprising a plurality of wind turbine generator devices connected to system diagnostics, an AC inverter, and either a local circuit or the power grid.

### DETAILED DESCRIPTION OF PREFERRED EMBODIMENTS

The inventive spherical airfoil shape wind turbine 10 provides currently available, viable solutions to many of the challenges noted above that are preventing wider acceptance and use of wind energy devices.

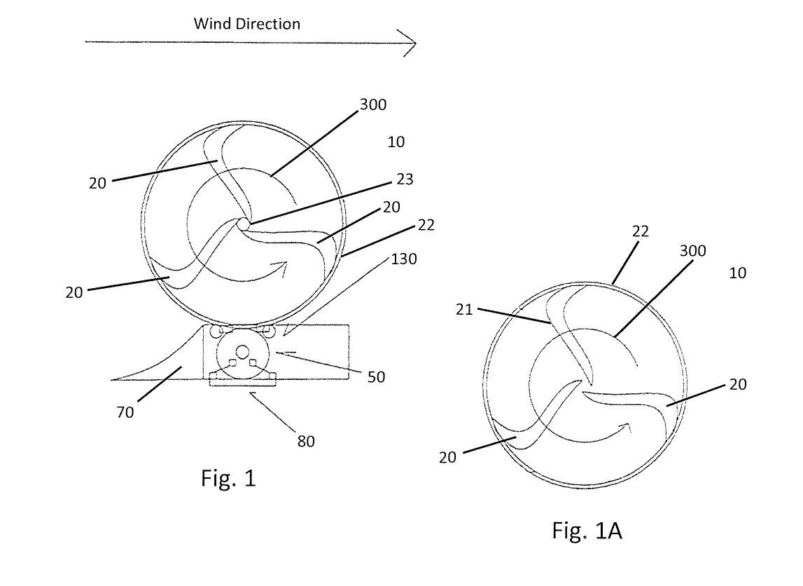

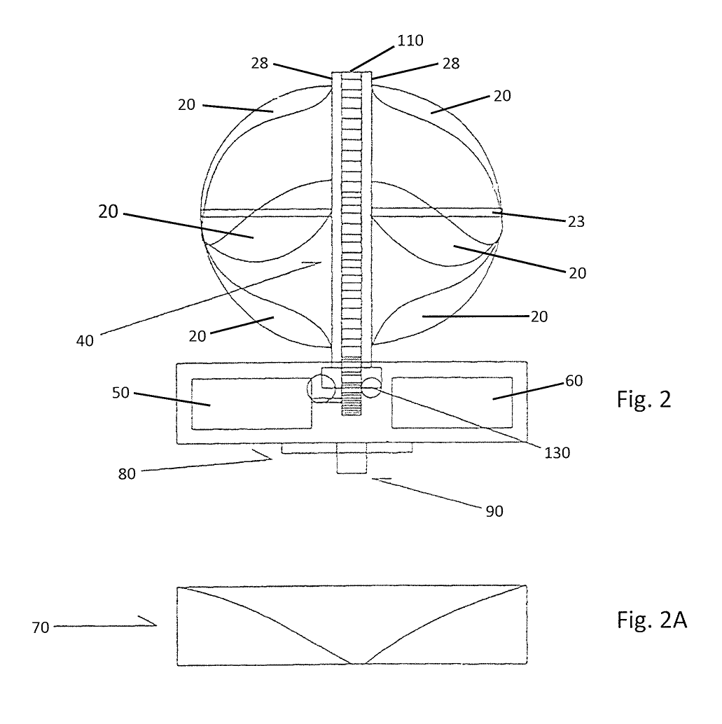

In preferred embodiments, the present invention offers a multi blade/airfoil design formed on two connected hemispheres. In order for a wind turbine to be used in a wide range of situations, locations and applications it must be safe to install, safe in operation and, to the extent possible, safe for people to be near within a reasonable proximity while it is operating. The proposed design achieves this objective in part using a plurality of airfoil blades 20 that, as shown in FIG. 1, are curved from the rotational axis 23 to a hemispheric base/perimeter 22 thereby having no blade ends or tips exposed. As shown in FIG. 2, the two hemispheres are connected at the circumference 28 of each hemisphere, or the equator of the sphere 40, to form a unified single unit.

As noted and shown in FIGS. 1, 1A, and 2, the single spherical shape has no free blade or propeller ends that are rotating in free space that could strike objects that may traverse into the path of a blade. Given that the plurality of blades 20 have attachment points at both ends, being the rotational axis 23 and the hemisphere circumference 28, there are no single spinning blade ends, and there is a significantly decreased risk of an airfoil blade 20 from releasing off the turbine device. The shape of the inventive spherical turbine 10 is benign in that should the sphere disengage from the base of the unit, it would do no more than roll away posing little safety or property damage risk.

The inventive wind turbine design 10 has a horizontal axis design which allows the unit's blades to take advantage of airfoil lift, wind force on the cambered side of the airfoil blade 20, while also using the counterweight forces of the downward moving blades 20 to help propel the turbine 10, and thereby increase both torque and rotational speed.

As compared to more typical HAWT turbines having multiple blades, the dual hemispheres double the number of blades 20 exposed the wind, and thereby substantially increase the blades surface area used to generate rotational motion, and thereby generate electrical power for a turbine unit.

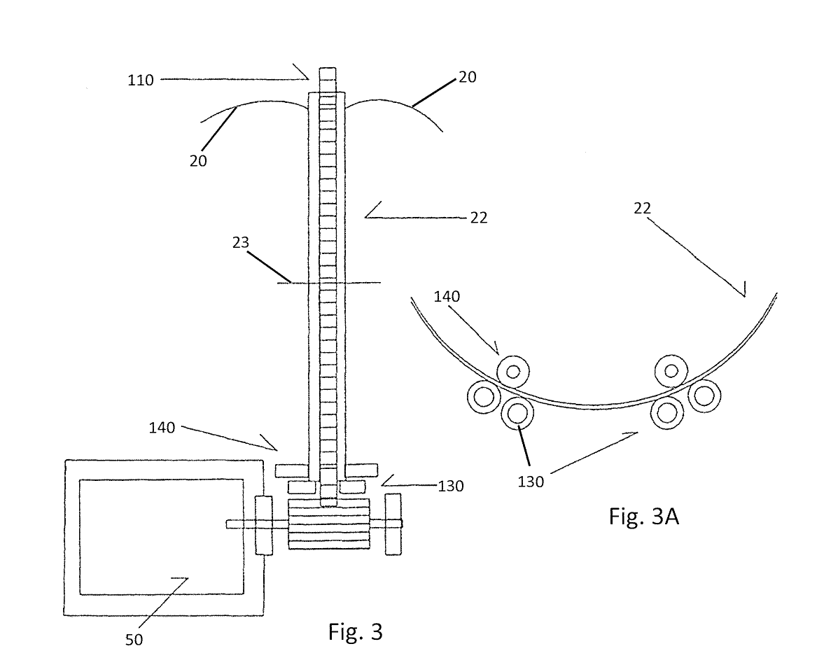

FIGS. 2 through 4 illustrate, in a preferred embodiment, side and frontal views of the wind turbine unit's motor/generator 50 as driven by a vertical center equator/circumference gear 110. FIG. 2A shows a base element or base vane 70 used to further direct wind to the blades 20.

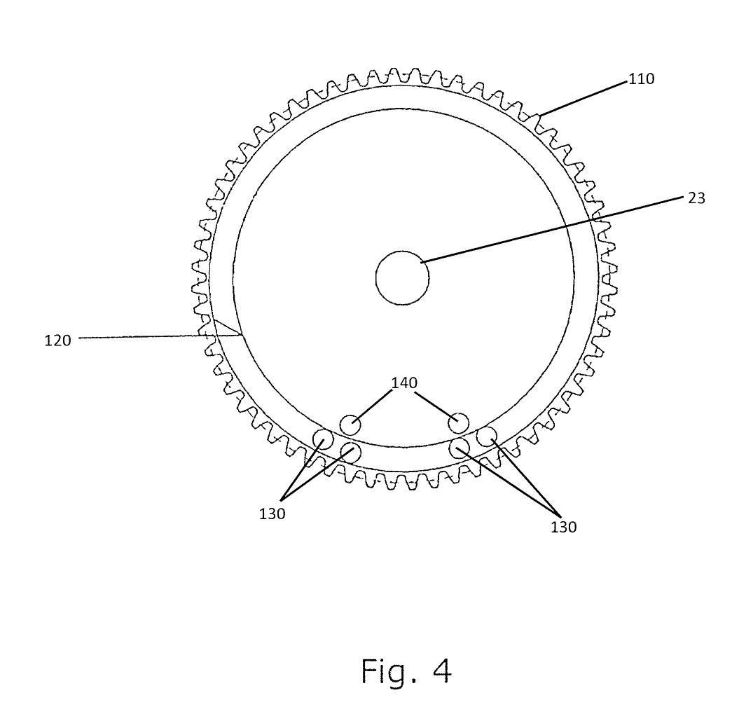

The main gear 110 located at the circumference 22 or equator of the sphere (also being the base where the two hemispheres are connected) is capable of generating high revolutions within the unit's generator 50 via a high gear ratio between the sphere and the generator's rotor gear. Using the sphere circumference 22 as the main gear for driving the generator 50 also contributes to the unit's distinctive design, compact size and low profile. As shown in FIG. 4, the main gear 110 is maintained in place and rotational speed controlled by a series of roller bearings 130 and 140. A running ring 120 is held in place by the roller bearings 130 and 140. The outer bearings 130 along with the inner bearings 140 can be used to control the speed and direction of rotation of the spherical turbine 10.

The shape of the inventive wind turbine blades 20, in preferred embodiments, may have varied airfoil shapes to create optimum lift on the upward and windward segments of the hemisphere's rotation. A variety of airfoil designs may be offered depending on the unit's deployment application including, among other applications, low wind speed, vortex flows, turbulent flows, and high wind speeds. More particularly, the inventive design is not limited to any particular airfoil shape, and indeed, in preferred embodiments, different application inventive wind turbine generators 10 may likely have varying airfoil designs, or even varying airfoil designs within a single blade or single wind turbine generator.

The turbine generator device 10 is designed to be a modular-type unit and could be easily installed as a complete unit with little to no assembly required. The device could be readily attached to a mount or mounting track in the case of a series of units. Prior art devices have shown that site assembly, maintenance and disassemble of wind turbines is a major safety risk related to free moving parts. In preferred embodiments, the inventive wind turbine 10, with its modular design allows for easy maintenance or repair. Indeed, where installed as a series of units, a single or multiple units could be easily taken out of operation for a period of time for any reason, by simply detaching the entire unit from its mount and removing it as a whole. Moreover, the curved blades 22 on the dual hemispheres can be easily locked down to prevent any possibility of inadvertent movement while being handled or transported.

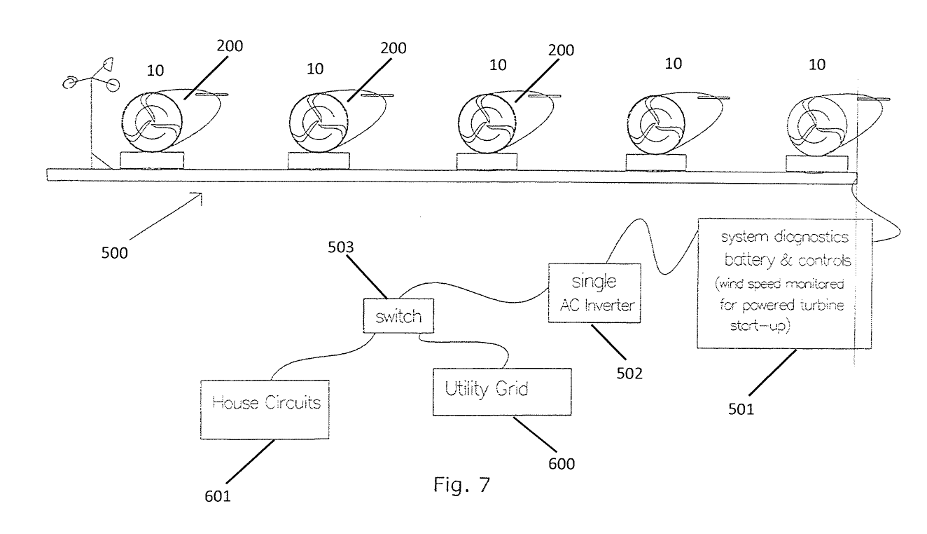

Each wind turbine unit 10 is capable of generating direct current (“DC”) electrical current that is transmitted to a control unit, as illustrated in FIG. 2, which then may be used to start-up the system's turbines if necessary, based on analysis and comparison of data from an integrated anemometer (shown in FIG. 7). The central processing and control unit 60, as shown integrated in the unit base, in FIG. 2, will also be able to brake or reduce rotational speed 300 of the blades in higher wind conditions, and thereby prevent potential damage to the motor/generators 50 during high wind conditions. The control/processing unit (“CPU”) 60 is also able to monitor and control the flow of electrical current to an AC inverter, and to switch between onsite usage of the electricity generated, or transmission of the generated electricity to the “grid” for net-metering operation, thereby saving the user further costs of operation. The CPU 60 will also be able to alert the operator to possible unit malfunctions.

Using a plurality of units 10 at a given site increases the utilization of available wind by the multiple of the number of units 10 in comparison to the same site that would only be able to support one larger wind turbine device. In such a multi-unit embodiment, the wind turbine will also achieve lower costs because the plurality of units 10 deployed at a single site may be able to use/share certain control equipment, including system controls, inverters and anemometers.

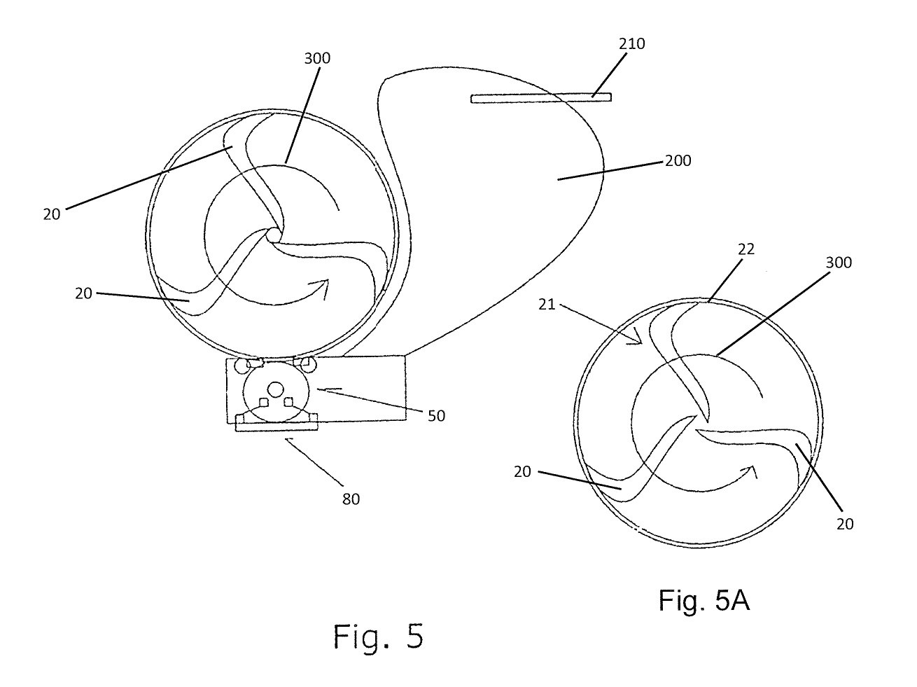

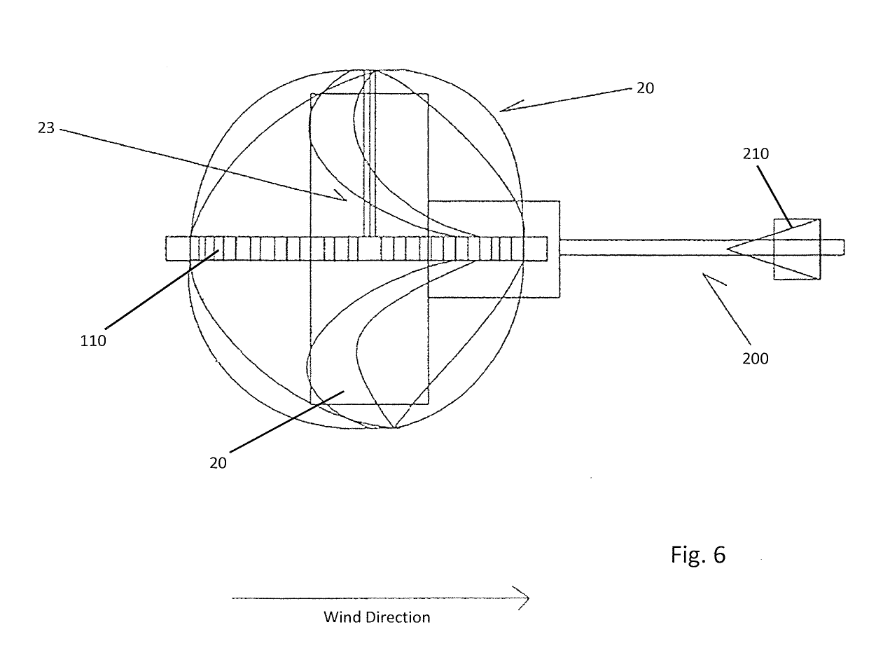

In another preferred embodiment, the inventive wind turbine 10 may use one or more vertical directional stabilizers 200, as shown in FIGS. 5 through 7, on each turbine unit 10 to allow independent direction operation according to varying wind conditions. This directional flexibility allows independent units 10 to take advantage of turbulent wind conditions by adjusting direction of each turbine unit 10 based upon wind direction at that unit's location. The vertical directional stabilizers 200 may each have a horizontal stabilizer 210. The wind turbines 10 are able to independently swivel, in this preferred embodiment, through use of a swivel table 80 and 360° slip ring 90.

In still another preferred embodiment, the inventive wind turbine's airfoil blades 20 may be equipped with flexible or hinged trailing edge flaps (not shown) to increase the aerodynamic forces on the cambered side of the airfoil when extended and during the blade upward rotation. The flap mechanisms could remain extended as the blade's leading edge 21 is moving windward, and the flaps could then retract to lessen drag as the blade 20 falls on the downward segment of the blade's rotation. Hinge stops (not shown) could be used for the flaps to dampened movement and to reduce further undesired acoustics.

In a preferred embodiment of the inventive design, the turbine 10 as shown in FIG. 7, allows for a plurality of wind turbine devices 10 to be connected in series. The wind turbine units 10, each with a low profile and relatively small size, are designed to be installed on a securely fastened mount, bracket or track 500, which can in turn be installed on a structure roof or on any type of structure with suitable space and exposure to wind flows. The FIG. 7 embodiment illustrates, in a preferred embodiment, the option of a small size turbine 10 allowing for a plurality of units 10 to be deployed in series or multiple series depending on the space/area available. As further shown in FIG. 7, the series of wind turbine devices 10 may be connected in series to a CPU 60 including system diagnostics and controls 501. The diagnostic and controls unit 501 may then be electrically connected to an AC inverter 501 and in turn to a switch 503. The switch 503 is provided to allow the turbine 10 to provide the generated electricity to the circuitry of the local structure (being a house, residence or business) 601 or to provide the electricity directly to the public power grid 600. Given the smaller size of the units and the ability to remove any unit 10 off line, the wind turbine units 10 can be readily transported to other locations where electricity may be needed.

In further preferred embodiments, the inventive wind turbine system can eliminate many external costs, and therefore allow for low initial capital expenditure for users. Because the device can be deployed on roof tops in view of its low-profile, smaller size, and lower-weight design, there will be little need for extensive and/or expensive structural reinforcement construction. Further, the low vibration characteristics of the wind turbine unit may also allow its usage on structures that could be otherwise restricted. Because the device will be able to efficiently operate under low wind conditions and take advantage of most all available wind with multiple units it will achieve relatively high overall efficiency as a system.

Finally, in view of the aesthetically pleasing shape and design of the inventive wind turbine, it is believed that it will achieve acceptance levels not observed with other types of wind energy devices. Accordingly, the wind turbine design will likely be more welcome in a larger number of communities and visual settings. The relatively smaller-sized wind turbine units will operate with less noise and will, accordingly, have a minimal impact on wildlife. Because the inventive wind turbines can be placed in a decentralized manner on or near residences, it will not be necessary to place large wind turbine farms in remote areas that may be environmentally sensitive. The result will be a decrease in the overall threat to wildlife from the expansion of large wind power systems.

While the present invention is described herein with reference to illustrative embodiments for particular applications, it should be understood that the invention is not limited to those specific examples, and that there are equally possible other wind turbine systems or turbine elements having equivalent performance and results. Those having ordinary skill in the art and access to the teachings provided herein will recognize additional modifications, applications, embodiments and substitution of equivalents all of which are within the scope of the inventive wind turbine power generator configurations and systems disclosed. Accordingly, the invention is not to be considered as limited by the foregoing description.

What I claim is:

1. A wind turbine generation device for creating electrical energy from a spherical-shaped wind-driven turbine comprising:
a. a spherical-shaped element comprising a plurality of blades each having a proximate end and a distal end, wherein said plurality of blades are shaped and formed into a spherical shape wherein said proximate end of each of said plurality of blades are connected at a center axis; said distal end of each of said plurality of blades are connected to a circumference of said spherical shape;
b. a gear element attached to said spherical-shaped element; and
c. a generator driven by said gear element as said spherical-shaped element rotates as a result of wind forces, wherein said generator creates electricity as it is driven by said spherical-shaped element.

2. The wind turbine generation device, as described in claim 1, wherein said gear element is attached along the circumference of the spherical-shaped wind turbine device.

3. The wind turbine generation device, as described in claim 1, further comprising a directional rudder to assist in swiveling the wind turbine along prevailing wind direction.

4. The wind turbine generation device, as described in claim 1, further comprising a computer processor to control the electricity created by said generator.

5. The wind turbine generation device, as described in claim 1, further comprising a computer processor to monitor the electricity created by said generator.

6. The wind turbine generation device, as described in claim 1, further comprising a computer processor to monitor any fault conditions.

7. The wind turbine generation device, as described in claim 1, wherein three airfoil blades are used on each side of a hemisphere to form said spherical-shaped turbine.

8. The wind turbine generation system comprising a plurality of wind turbine generation devices, wherein each said plurality of wind turbine generation devices comprises:
a. a spherical-shaped element comprising a plurality of blades each having a proximate end and a distal end, wherein said plurality of blades are shaped and formed into a spherical shape wherein said proximate end of each of said plurality of blades are connected at a center axis; said distal end of each of said plurality of blades are connected to a circumference of said spherical shape;
b. a gear element attached to said spherical-shaped element; and
c. a generator driven by said gear element as said spherical-shaped element rotates as a result of wind forces, wherein said generator creates electricity as it is driven by said spherical-shaped element.

9. The wind turbine generation system, as described in claim 8, wherein a plurality of the wind turbine generation devices are electrically connected in series.

10. A method for generating electrical power from wind energy using a wind turbine generation device comprising a spherical-shaped wind-driven turbine device, where the wind turbine generation device comprises:
a. a spherical-shaped element comprising a plurality of blades each having a proximate end and a distal end, wherein said plurality of blades are shaped and formed into a spherical shape wherein said proximate end of each of said plurality of blades are connected at a center axis; said distal end of each of said plurality of blades are connected to a circumference of said spherical shape;
b. a gear element attached to said spherical-shaped element; and
c. a generator driven by said gear element as said spherical-shaped element rotates as a result of wind forces, wherein said generator creates electricity as it is driven by said spherical-shaped element.
